(19) United States
(12) Patent Application Publication
(10) Pub. No.: US 2009/0314122 A1
(43) Pub. Date: Dec. 24, 2009

(54) APPARATUS FOR AUTOMATICALLY ADJUSTING TENSION OF CABLE IN PARKING BRAKE AND PARKING BRAKE APPARATUS USING THE APPARATUS

(75) Inventors: Sug-Jun Youn, Gyeongsan-si (KR); Hee-Gon Lee, Gyeongsan-si (KR)

Correspondence Address: LANDO & ANASTASI, LLP, ONE MAIN STREET, SUITE 1100, CAMBRIDGE, MA, 02142, US

(73) Assignee: SL Corporation, Daegu (KR)

(21) Appl. No.: 12/484,612

(22) Filed: Jun. 15, 2009

(30) Foreign Application Priority Data
Jun. 18, 2008 (KR) 10-2008-0057505

(51) Int. Cl. B60T 11/06; B60T 11/04; G05G 1/04; B60T 7/08; F16C 1/22

(52) U.S. Cl. 74/501.5 R; 74/501.6

(57) ABSTRACT

Provided are an apparatus for adjusting the tension of a cable used in a parking brake and a parking brake apparatus using the apparatus. The apparatus for automatically adjusting the tension of a cable in a parking brake includes: a rod which includes saw teeth in a portion of an outer circumferential surface thereof and has an end connected to the cable; an elastic member which, when the cable is loosened, moves the rod with an expansive force thereof to stretch the cable; and a pawl which engages with the saw teeth of the rod to hinder the rod from moving in a direction that contracts the stretched cable; wherein the elastic member provides the expansive force to the rod, and the rod is moved by the expansive force to stretch the cable, thereby maintaining the tension of the cable.

This application claims priority from Korean Patent Application No. 10-2008-0057505 filed on Jun. 18, 2008 in the Korean Intellectual Property Office, the disclosure of which is incorporated herein by reference in its entirety.

### BACKGROUND OF THE INVENTION

1. Field of the Invention

The present invention relates to an apparatus for automatically adjusting the tension of a cable used in a parking brake and a parking brake apparatus using the apparatus, and more particularly, to an apparatus for adjusting the tension of a cable used in a parking brake and a parking brake apparatus using the apparatus.

2. Description of the Related Art

Generally, parking brake apparatuses for vehicles (also known as hand brakes or side brakes) are used to stop or park a vehicle. Parking brake apparatuses keep a vehicle stationary and apply a parking brake to rear or front wheels of the vehicle in order to maintain a parked state of the vehicle. Parking brake apparatuses include a parking brake drum, a parking brake shoe, and a spring and apply a parking brake to wheels by firmly attaching the parking brake shoe to the parking brake drum.

When a driver pulls a lever of a parking brake, a cable of the parking brake is stretched, thereby applying the parking brake. On the other hand, when the driver releases the lever, the cable of the parking brake is loosened, thereby releasing the parking brake.

Since the driver frequently pulls or releases the lever of the parking brake to park the vehicle, the cable of the parking brake may repeatedly be exposed to tensile stress. Such pulling and releasing of the parking brake may be repeated until the useful life of the vehicle or the parking brake is over. Whenever the parking brake is operated, the cable may be deformed by a repeated tensile force, permanently deformed by an excessive tensile force or fatigue experienced for a long time, or may suffer from the deterioration of its durability. As a result, the length of the cable may be increased and thus become loose.

When the cable is loose, if the parking brake is operated, the lever of the parking brake should be pulled further than before. However, if the lever of the parking brake has a longer stroke due to the loosening of the cable, thereby stretching the cable to more than a predetermined length, the parking brake may substantially not be able to perform its function.

If a parking brake apparatus cannot keep a vehicle in a parked state, serious safety problems may arise. For example, if a parking brake apparatus of a vehicle parked on a sloping road surface in a residential area cannot perform its function due to the loosening of a cable, the parked vehicle may slide down the sloping road surface, which may result in vehicle collisions or a loss of lives.

Accordingly, this has led to a demand for an apparatus for uniformly adjusting the tension of a cable of a parking brake and a parking brake apparatus for maintaining the tension of the cable, so that the parking brake can be applied to wheels of a vehicle even when the length of the cable is changed.

### SUMMARY OF THE INVENTION

Aspects of the present invention provide an apparatus for adjusting the tension of a cable of a parking brake within a predetermined range and enabling the parking brake to continuously perform its function by automatically stretching the cable when the cable is loosened.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided an apparatus for automatically adjusting the tension of a cable in a parking brake. The apparatus includes: a rod which includes saw teeth in a portion of an outer circumferential surface thereof and has an end connected to the cable; an elastic member which, when the cable is loosened, moves the rod with an expansive force thereof to stretch the cable; and a pawl which engages with the saw teeth of the rod to hinder the rod from moving in a direction that contracts the stretched cable; wherein the elastic member provides the expansive force to the rod, and the rod is moved by the expansive force to stretch the cable, thereby maintaining the tension of the cable.

According to another aspect of the present invention, there is provided a parking brake apparatus for maintaining the tension of a cable. The apparatus includes: a brake lever which includes a lever hole and can rotate about the lever hole serving as a rotation axis; a shaft which is integrally fixed and inserted into the lever hole; a cable-fixing unit which prevents the contraction of the cable; an arm housing which is integrally fixed to the shaft, is rotated by the rotation of the shaft, and accommodates the cable-fixing unit; and a cable-adjusting unit which stretches the cable with an expansive force when the cable is loosened, wherein the cable-adjusting unit includes: a rod which is connected to the cable and comprises saw teeth in a portion of an outer circumferential surface thereof; and an elastic member which is compressed and then inserted between an end of the rod and the cable-fixing unit, wherein the cable-adjusting unit, before the brake lever is operated, pushes the rod with the expansive force of the elastic member to stretch the cable, and the cable-fixing unit keeps the cable stretched by using a pawl.

### BRIEF DESCRIPTION OF THE DRAWINGS

The above and other aspects and features of the present invention will become more apparent by describing in detail exemplary embodiments thereof with reference to the attached drawings, in which:

FIG. 1 is an exploded perspective view of a parking brake apparatus for maintaining the tension of a cable according to an embodiment of the present invention;

FIG. 2 is a perspective view of the parking brake apparatus shown in FIG. 1;

FIG. 3 is a schematic diagram of an apparatus for automatically adjusting the tension of a cable in a parking brake according to an embodiment of the present invention before the apparatus is operated according to an embodiment of the present invention;

FIG. 4 is a schematic diagram of the apparatus of FIG. 3 after operated according to an embodiment of the present invention; and

FIG. 5 is a perspective view of the apparatus shown in FIG. 3; and

FIGS. 6A through 6C sequentially show processes of operating the parking brake apparatus shown in FIG. 1.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Hereinafter, exemplary embodiments of the present invention will be described in detail with reference to the attached drawings.

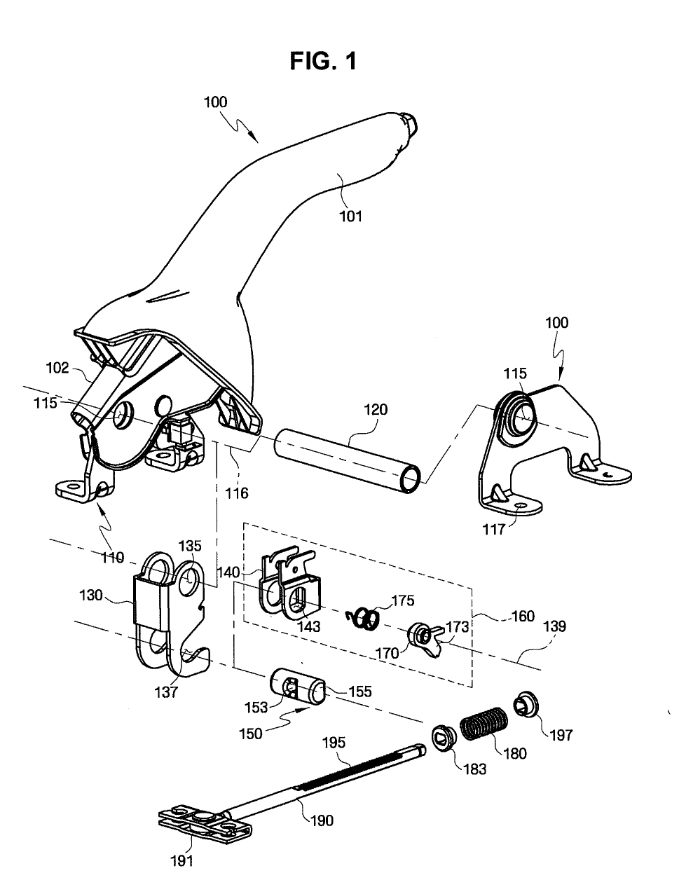

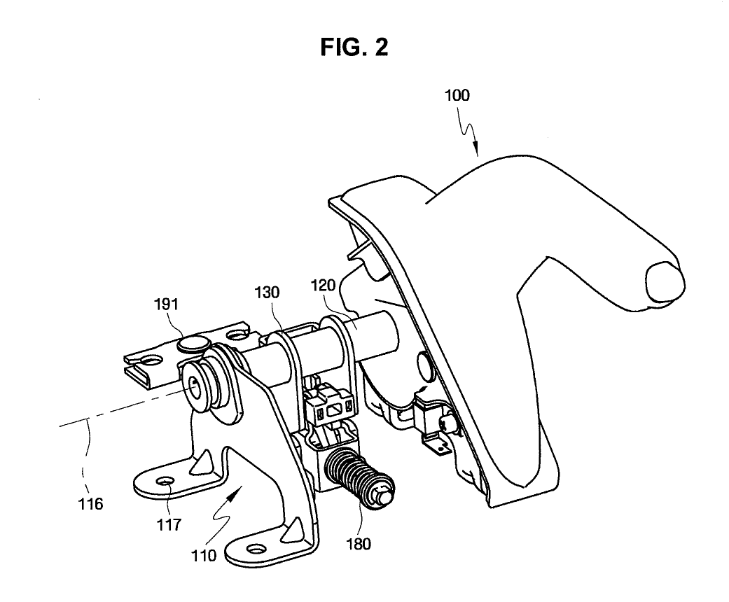

FIG. 1 is an exploded perspective view of a parking brake apparatus for maintaining the tension of a cable according to an embodiment of the present invention. FIG. 2 is a perspective view of the parking brake apparatus shown in FIG. 1.

Referring to FIGS. 1 and 2, the parking brake apparatus according to the present embodiment may include a brake lever 100, a fixing holder 110, a shaft 120, an arm housing 130, a cable-fixing unit 160, a rod guider 150, a rod 190, and an elastic member 180.

The brake lever 100 is manipulated directly by a driver to operate or release the parking brake apparatus. The brake lever 100 may include a lever rod 101 which functions as a handle and a lever body 102 which rotates about a predetermined rotation axis according to strokes of the lever rod 101.

The fixing holder 110 may fix the brake lever 100 to a body (not shown) of a vehicle. The fixing holder 110 may be connected to the brake lever 100 by the shaft 120 which will be described later. The fixing holder 110 may include holes 117 which are used to fix the fixing holder 110 to the body of the vehicle and a lever hole 115 which provides a rotation axis of the shaft 120.

The shaft 120 penetrates the lever hole 115 and is fixedly connected to the brake lever 100. The shaft 120 may be rotated by the movement of the brake lever 100. When a driver pulls or releases the brake lever 100, the shaft 120 integrally connected to the brake lever 100 may rotate about a rotation axis 116. The rotation of the shaft 120 may induce the arm housing 130, which is fixedly connected to the shaft 120 and will be described later, to rotate.

The arm housing 130 accommodates the cable-fixing unit 160 which will be described later. The arm housing 130 may be fixed to the shaft 120 which is rotated by the rotation of the brake lever 100. Accordingly, the arm housing 130 may be rotated by the rotation of the shaft 120. The arm housing 130 may include shaft holes 135 in an upper part thereof and hinges 137 or housing holes (not shown) in a lower part thereof. The shaft holes 135 are used to fix the arm housing 130 to the shaft 120, and the hinges 137 or the housing holes are where the rod guider 150 rests. The rod guider 150 guides the movement of the rod 190 while maintaining its attitude relative to the rotation of the arm housing 130. As used herein, the term “attitude” denotes a direction in which the front or rear of the road guider 150 faces. While a direction angle of the arm housing 130 is changed by the rotation thereof, the attitude in which the rod guider 150 faces, e.g., a direction angle of the rod guider 150, may relatively be fixed.

The rod guider 150 rests on the hinges 137 or the housing holes of the arm housing 130 and guides the movement of the rod 190. The rod guider 150 may maintain an attitude of the cable-fixing unit 160 which is housed in the arm housing 130 and hinders contraction of the cable. To maintain the attitude of the cable-fixing unit 160 which will be described later, a portion of an outer surface of the rod guider 150 may not be cylindrical. Instead, the portion of the outer surface of the rod guider 150 may be a linear surface 155, a groove, or a protrusion. The linear surface 155, the groove, or the protrusion of the rod guider 150 is used to couple the rod guider 150 to a pawl housing 140 which will be described later. Thus, even when the arm housing 130 rotates about the rotation axis 116, the rod guider 150 can be prevented from rotating about an axis 139.

The cable-fixing unit 160 prevents the contraction of the cable. When the cable is stretched, the cable-fixing unit 160 hinders the movement of the cable by using a pawl 170 in order to prevent the contraction of the cable.

The cable-fixing unit 160 may include the pawl housing 140, the pawl 170, and a torsion spring 175. The pawl housing 140 accommodates the pawl 170 and the torsion spring 175 and provides a space in which the pawl 170 operates. The pawl housing 140 may include rod holes 143 into which the rod guider 150 is inserted. A portion of each of the rod holes 143 may be linear, a protrusion, or a groove to engage with a portion of the outer surface of the rod guider 150. When the linear surface 155 of the rod guider 150 engages with the pawl housing 140 as described above, the attitude of the rod guider 150 and that of the pawl housing 140 can be maintained together. For example, even when the arm housing 130 rotates, the direction in which the rod guider 150 faces may remain unchanged. Accordingly, the direction in which the pawl housing 140 faces may also remain unchanged.

Meanwhile, to engage and thus couple the rod guider 150 with/to the pawl housing 140, a portion of the outer surface of the rod guider 150 may not be formed cylindrical as described above. Alternatively, the rod guider 150 and the pawl housing 140 may be integrally coupled to each other using a wedge. Alternatively, the rod guider 150 and the pawl housing 140 may be manufactured as a single body. Alternatively, techniques known to those of ordinary skill in the art to which the present invention pertains may be used to rotate the rod guider 150 and the pawl housing 140 together.

The pawl 170 prevents the contraction of the cable when the cable is stretched. The pawl 170 may include a pawl protrusion 173 facing in a predetermined direction, and the pawl protrusion 173 may engage with saw teeth 195 of the rod 190 and thus hinder the movement of the rod 190. When the rod 190 is pushed backward by the expansive force of the elastic member 180 which will be described later, the pawl 170 cannot hinder the movement of the rod 190. However, when the rod 190 is to move in the reverse direction to cause the contraction of the cable, the pawl 170 hinders the movement of the rod 190. Thus, the tension of the cable can be maintained.

The torsion spring 175 maintains the direction in which the pawl protrusion 173 of the pawl 170 faces. The torsion spring 175 provides a force that causes the pawl 170 to be twisted in a clockwise direction, thereby making the pawl protrusion 173 of the pawl 170 contact the saw teeth 195 of the rod 190.

The rod 190 is a rigid body having a predetermined length. An end of the rod 190 may be connected to the cable, and the saw teeth 195 may be formed in a portion of an outer surface of the rod 190. Here, the saw teeth 195 can hinder the movement of the pawl protrusion 173 of the pawl 170. The saw teeth 195 may be a plurality of grooves or may be a plurality of protrusions and grooves.

An end of the rod 190 may be directly connected to the cable. Alternatively, an equalizer 191 may be installed at an end of the rod 190 and connect the cable, which is connected to each of both wheels of the vehicle, to the rod 190. When the rod 190 is connected to the cable, the tension of the cable can be maintained by moving the rod 190. The saw teeth 195 of the rod 190 contact the pawl protrusion 173 of the pawl 170. When the rod 190 moves in a direction that increases the tension of the cable, the pawl protrusion 173 cannot engage with the saw teeth 195, thereby failing to hinder the movement of the rod 190. When the rod 190 moves in a direction that contracts the cable, the pawl protrusion 173 engages with the saw teeth 195, thereby hindering the movement of the rod 190.

The rod 190 may include a stopper 197 at the other end thereof. The stopper 197 receives the expansive force of the elastic member 180, which is inserted onto the rod 190, and delivers the expansive force to the rod 190. In addition, the stopper 197 keeps the elastic member 180 in a compressed state and is fixed to the end of the rod 190 to prevent the elastic member 180 from being decoupled from the rod 190. In case the elastic member 180 stretches and thus its compressive force decreases, the position of the stopper 197 on the rod 190 may be adjusted. For example, if the stopper 197 is screw-coupled to the rod 190, its position on the rod 190 can be adjusted by rotating the stopper 197.

The elastic member 180 is inserted onto the rod 190 in a lengthwise direction of the rod 190 and delivers an elastic force to the rod 190. The elastic member 180 is in the compressed state when inserted onto the rod 190. In this state, if the cable is loosened, the elastic member 180 delivers its expansive force to the rod 190, thereby adjusting the tension of the cable. The expansive force pushes the rod 190 backward, which, in turn, stretches the cable connected to the rod 190. In addition, the elastic member 180 is inserted, in the compressed state, between the pawl housing 140 and the stopper 197. When the cable is loosened, the elastic member 180 pushes the stopper 197, thereby stretching the cable. The elastic member 180 can compress or stretch due to its elastic force. The elastic member 180 may be, for example, a spring which can provide a sufficient elastic force. A bush 183 may further be installed in front of or behind the elastic member 180 in order to easily deliver the compressive force of the elastic member 180.

In the present embodiment, when the cable becomes loose, the tension of the cable can be maintained by stretching the cable as described above. Moreover, when the cable is stretched, it can be prevented from contracting by using the pawl 170. Accordingly, the tension of the cable can be maintained.

An apparatus for automatically adjusting the tension of a cable in a parking brake according to an embodiment of the present invention may include the rod 190, the elastic member 180, the pawl 170, the pawl housing 140, the arm housing 130, and the rod guider 150. Since each component of the apparatus for automatically adjusting the tension of the cable was described in detail when each component of the parking brake apparatus was described, a description thereof will be omitted.

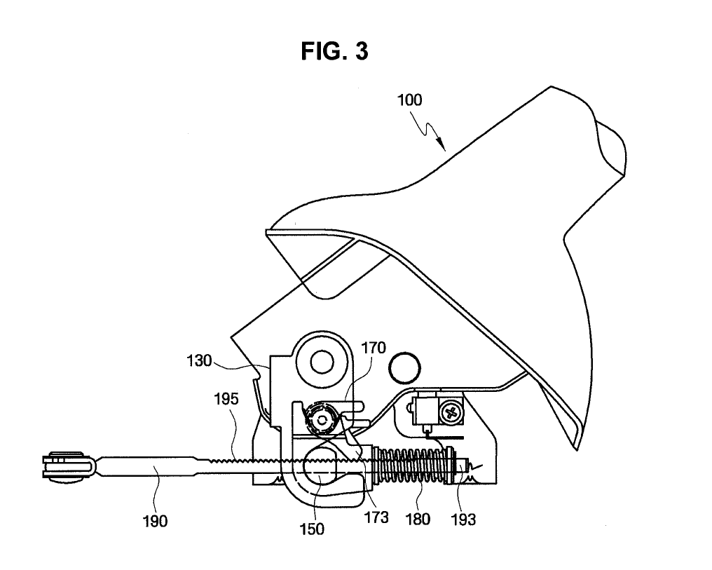

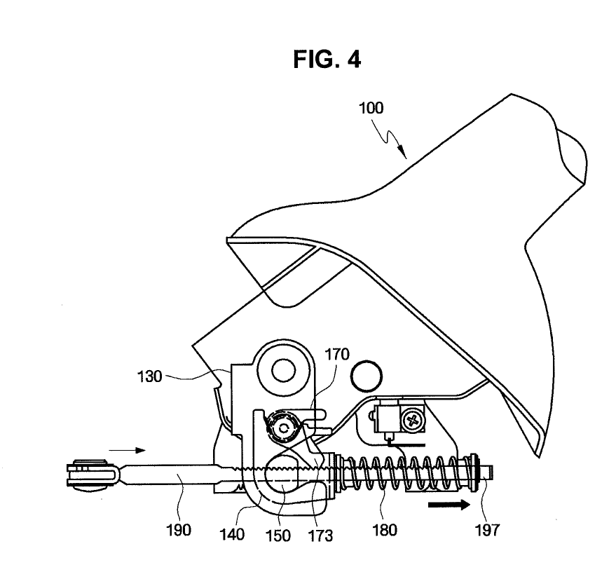

FIG. 3 is a schematic diagram of an apparatus for automatically adjusting the tension of a cable in a parking brake according to an embodiment of the present invention before the apparatus is operated according to an embodiment of the present invention (?). FIG. 4 is a schematic diagram of the apparatus of FIG. 3 after operated according to an embodiment of the present invention.

Referring to FIG. 3, a brake lever 100 is lowered to its lowest position, and thus a packing brake is released. In addition, an elastic member 180 of the apparatus for automatically adjusting the tension of the cable remains in its original state. An equalizer 191 is connected to an end of a rod 190 and connects a cable (not shown) to the rod 190. The cable is connected to a left side of the equalizer 191. When in the compressed state, the elastic member 180 provides its expansive force to a stopper 197 of the rod 190. Then, the stopper 197 of the rod 190 receives the expansive force and delivers the expansive force to the rod 190.

However, since the rod 190 is connected to the cable and keeps the cable stretched, a force provided to the rod 190 due to the expansive force may act on the cable as tension. Therefore, if the cable is not loose with sufficient tension applied thereto, even when the expansive force of the elastic member 180 acts on the rod 190, it cannot push the rod 190 backward. Accordingly, the tension of the cable can be maintained within a predetermined range.

When the rod 190 is moved by the expansive force of the elastic member 180, a pawl 170 does not hinder the movement of the rod 190. This is because a pawl protrusion 173 of the pawl 170 does not engage with saw teeth of the rod 190 that is moved by the expansive force. Thus, as the rod 190 moves, the pawl protrusion 173 of the pawl 170 may be moved up or down by a height of the saw teeth 195 of the rod 190 due to the movement of the saw teeth 195.

Referring to FIG. 4, while the parking brake is still released, the elastic member 180 of the apparatus for automatically adjusting the tension of the cable is not in its original state. When the cable of the parking brake is loosened, the tension acting on the cable may be reduced. Here, since the expansive force of the elastic member 180 is greater than the tension of the cable, it may act on the rod 190, thereby pushing the rod 190 backward.

As the rod 190 is pushed backward, it may pull the cable. Accordingly, the cable may be stretched by the elastic force of the elastic member 180. The tension reduced when the cable was loosened may be increased again due to the elastic force. Here, the tension of the cable may be increased by the expansive force of the elastic member 180. Therefore, as a length of the cable increases, a length of the elastic member 180 may also be increased, which, in turn, reduces the expansive force of the elastic member 180. In this case, the position of the stopper 197 on the rod 190 may be adjusted to control the length of the elastic member 180.

When the movement of the rod 190 due to the expansive force is terminated, the pawl 170 may hinder the reverse movement of the rod 190. Here, “reverse movement” refers to the movement of the rod 190 in a direction that contracts the cable, that is, in a reverse direction to the direction in which the rod 190 is moved by the expansive force. When the rod 190 moves in the reverse direction, the saw teeth 195 of the rod 190 engage with the pawl protrusion 173 of the pawl 170, thereby preventing the contraction of the cable. Since the cable is prevented from contracting, its tension can be maintained within a range of tension generated by the expansive force.

As described above, according to the present embodiment, when the cable is loosened, the expansive force of the elastic member 180 stretches the cable, thereby maintaining the tension of the cable within a predetermined range. In addition, when the cable is stretched due to the expansive force, the pawl 170 hinders the cable from contracting. As a result, the tension of the cable can be maintained in a reliable manner.

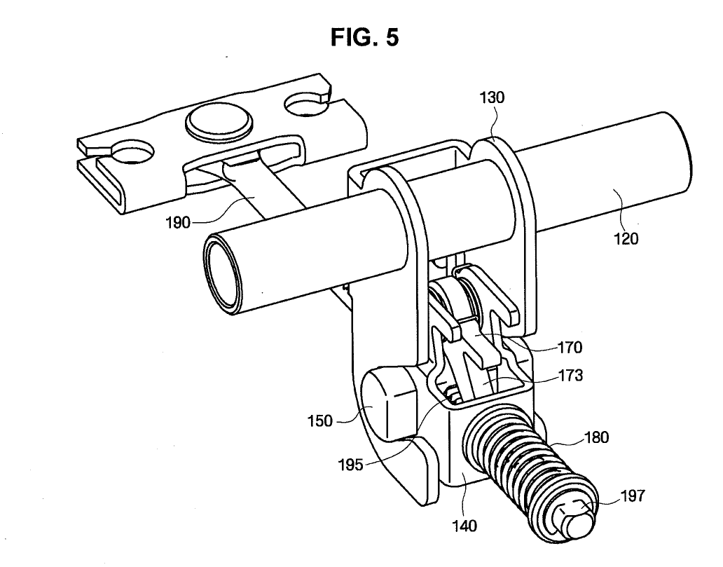

FIG. 5 is a perspective view of the apparatus shown in FIG. 3. The apparatus according to the present embodiment may include the rod 190, the elastic member 180, the pawl 170, a pawl housing 140, an arm housing 130, and a rod guider 150.

Referring to FIG. 5, the rod guider 150 rests on hinges 137 formed in a lower part of the arm housing 130 and is inserted into rod holes 143 formed in a lower part of the pawl housing 140. The rod guider 150 and the pawl housing 140 may include holes penetrated by the rod 190. Thus, even when the arm housing 130 rotates, respective direction angles of the rod guider 150 and the pawl housing 140 may remain unchanged since the rod 190 penetrates a hole 153.

The pawl 170 is accommodated in the pawl housing 140, and the pawl protrusion 173 of the pawl 170 may be put on the saw teeth 195 of the rod 190 by a torsion spring 175. The pawl protrusion 173 faces downward at an angle, and the torsion spring 175 provides a force that causes the pawl protrusion 173 to be twisted in a clockwise direction.

The elastic member 180 is positioned between the pawl housing 140 and the stopper 197 of the rod 190. The elastic member 180 is inserted onto the rod 190 when in a compressed state and provides an expansive force to the stopper 197. When the cable is loosened, the expansive force of the elastic member 180 moves the rod 190 backward, thereby compensating for a reduction in the tension of the cable resulting from the loosening of the cable.

The pawl 170 cannot hinder the rod 190 from being moved by the expansive force. However, when the rod 190 is moved in the reverse direction by the contraction of the cable, the pawl protrusion 173 of the pawl 170 engages with the saw teeth 195 of the rod 190, thereby hindering the reverse movement of the rod 190.

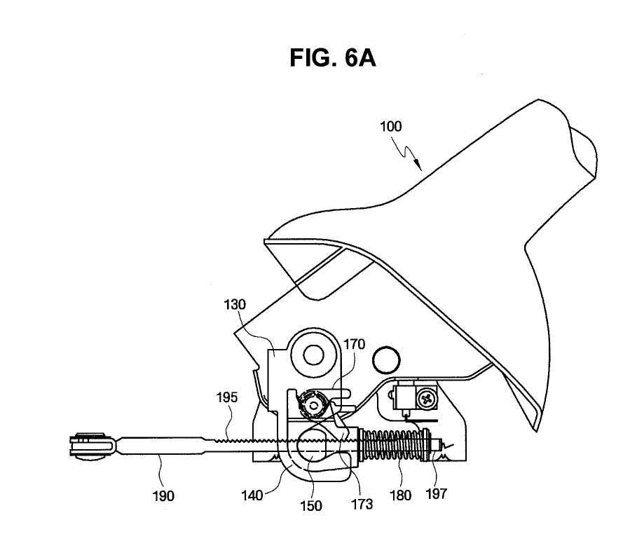

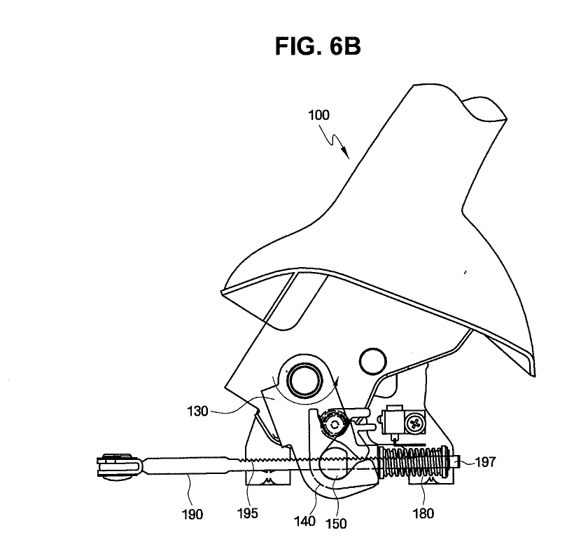

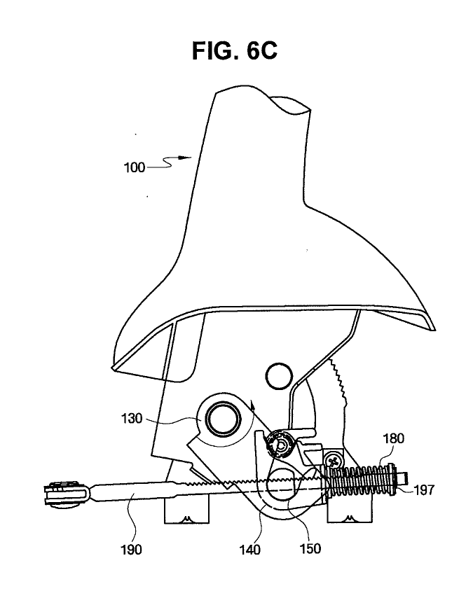

FIGS. 6A through 6C sequentially show processes of operating the parking brake apparatus shown in FIG. 1.

Referring to FIG. 6A, the brake lever 100 is lowered to its lowest position, and thus the parking brake apparatus is released. When the parking brake apparatus is released, the arm housing 130 may stand perpendicular to the rod 190. In addition, when the parking brake apparatus is released, the apparatus for automatically adjusting the tension of a cable shown in FIG. 3 may operate when the cable is loosened.

Referring to FIG. 6B, the brake lever 100 is rotated a predetermined angle compared to its orientation in FIG. 6A. That is, since a driver pulls the brake lever 100, the brake lever 100 is rotating about and the shaft 120.

The brake lever 100, the shaft 120, and the arm housing 130 are fixedly connected to each other. Thus, the shaft 120 and the arm housing 130 are rotated together by the rotation of the brake lever 100. The rod guider 150 and the pawl housing 140 may also be moved by the rotation of the arm housing 130. However, their attitudes may be fixed. This is because the rod guider 150 rests on the hinges 137 of the arm housing 130 and its rotation is hindered by the rod 190 that penetrates the hole 153 of the rod guider 150.

When the attitudes of the rod guider 150 and the pawl housing 140 are fixed, the arm housing 130 is rotated by the rotation of the brake lever 100, thereby moving the rod guider 150 and the pawl housing 140 backward. Accordingly, the rod 190 is moved backward, thus moving the cable.

Referring to FIG. 6C, the brake lever 100 is further rotated a predetermined angle compared to its orientation in FIG. 6B. That is, the driver has pulled the brake lever 100 to its highest position, and thus the parking brake apparatus can change the vehicle into a parked state.

As the brake lever 100 rotates, the shaft 120 and the arm housing 130 fixedly connected to the brake lever 100 may be rotated to the maximum extent possible. The rotation of the arm housing 130 may move the rod guider 150 and the pawl housing 140 to the rearmost position, thereby moving the cable as far as possible. Here, while the rod guider 150 and the pawl housing 140 are moved, their attitudes are maintained by the rod 150 that penetrates them

As the cable connected to wheels of the vehicle moves, it is stretched, thereby firmly attaching a parking brake shoe to a parking brake drum. In so doing, the parking brake can be applied to the wheels of the vehicle.

As described above, the parking brake apparatus according to the present embodiment can be effectively operated by operating the cable using the arm housing 130 and the rod guider 150. For example, while the attitude of the rod 190 is maintained using the rod guider 150, the rod 190 may be moved by rotating the arm housing 130, thereby moving the cable. As a result, the vehicle may be changed into a parked state. When the parking brake apparatus is in a released state in which the brake lever 100 is lowered to its lowest position, if the cable is loosened, the expansive force of the elastic member 180 may stretch the cable, thereby maintaining the tension of the cable within a predetermined range. Therefore, the rate at which the vehicle fails to be changed into the parked state due to the loosening of the cable can be reduced. In addition, changes in the length of the cable due to fatigue accumulated by repeated use, an impact, a high temperature, and deteriorated durability can be efficiently handled.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. An apparatus for automatically adjusting the tension of a cable in a parking: brake, the apparatus comprising:
a rod which comprises saw teeth in a portion of an outer circumferential surface thereof and has an end connected to the cable;
an elastic member which, when the cable is loosened, moves the rod with an expansive force thereof to stretch the cable; and
a pawl which engages with the saw teeth of the rod to hinder the rod from moving in a direction that contracts the stretched cable;
wherein the elastic member provides the expansive force to the rod, and the rod is moved by the expansive force to stretch the cable, thereby maintaining the tension of the cable.

2. The apparatus of claim 1, wherein when the rod moves in a reverse direction to a direction in which the rod is moved by the expansive force, the pawl engages with the saw teeth of the rod and hinders the reverse movement of the rod.

3. The apparatus of claim 1, wherein the pawl comprises:
a pawl protrusion which engages with the saw teeth of the rod ; and
a torsion spring which maintains a direction in which the pawl protrusion faces.

4. The apparatus of claim 1, further comprising an arm housing which accommodates the pawl and is rotated by the rotation of a brake lever.

5. The apparatus of claim 4, further comprising a rod guider which guides the movement of the rod while maintaining an attitude of the pawl with respect to an axis of the arm housing when the arm housing rotates.

6. The apparatus of claim 1, wherein the rod comprises a stopper which inhibits the expansion of the elastic member and is coupled to the rod such that a position of the stopper on the rod can be adjusted.

7. A parking brake apparatus for maintaining the tension of a cable, the apparatus comprising:
a brake lever which comprises a lever hole and can rotate about the lever hole serving as a rotation axis;
a shaft which is integrally fixed and inserted into the lever hole;
a cable-fixing unit which prevents the contraction of the cable;
an arm housing which is integrally fixed to the shaft, is rotated by the rotation of the shaft, and accommodates the cable-fixing unit; and
a cable-adjusting unit which stretches the cable with an expansive force when the cable is loosened,
wherein the cable-adjusting unit comprises:
a rod which is connected to the cable and comprises saw teeth in a portion of an outer circumferential surface thereof; and
an elastic member which is compressed and then inserted between an end of the rod and the cable-fixing unit,
wherein the cable-adjusting unit, before the brake lever is operated, pushes the rod with the expansive force of the elastic member to stretch the cable, and the cable-fixing unit keeps the cable stretched by using a pawl.

8. The apparatus of claim 7, wherein the cable-fixing unit comprises:
a pawl housing which provides a rotation axis of the pawl and guides the movement of the rod; and
a rod guider which guides the movement of the rod while maintaining an attitude of the pawl housing with respect to an axis of the arm housing when the arm housing rotates.

9. The apparatus of claim 7, wherein a pawl protrusion of the pawl of the cable-fixing unit does not engage with the saw teeth of the rod when the rod is moved by the cable-adjusting unit and engages with the saw teeth of the rod to hinder the movement of the rod when the rod moves in a direction that contracts the cable.
